(19) United States
(12) Patent Application Publication
(10) Pub. No.: US 2016/0350854 A1
(43) Pub. Date: Dec. 1, 2016

(54) Data Structure Management in Hybrid Clearing and Default Processing

(71) Applicant: Chicago Mercantile Exchange Inc., Chicago, IL (US)

(72) Inventors: Tim Elliott, Chicago, IL (US); Michael Kobida, Chicago, IL (US); Kevin Walker, Chicago, IL (US)

(21) Appl. No.: 15/170,573

(22) Filed: Jun. 1, 2016

Related U.S. Application Data
(60) Provisional application No. 62/169,152, filed on Jun. 1, 2015.

(51) Int. Cl. G06Q 40/04; G06Q 40/02

(52) U.S. Cl. CPC G06Q 40/04; G06Q 40/02

(57) ABSTRACT

Data structures for data transactions related to clearing are managed by: maintaining a market participant account data structure for the market participant and a guaranty fund data structure representative of a guaranty fund contribution made by a clearing member in support of the market participant; receiving transaction data for the market participant in connection with the transaction; determining a settlement data level for the transaction and for which the market participant is responsible; determining a guaranty fund contribution data level for the transaction and for which the clearing member is responsible; adjusting the market participant account data structure in accordance with the determined settlement data level; and, adjusting the guaranty fund data structure in accordance with the determined guaranty fund contribution data level.

### CROSS-REFERENCE TO RELATED APPLICATION

This application claims the benefit of U.S. provisional application entitled “Hybrid Clearing and Default Management,” filed Jun. 1, 2015, and assigned Ser. No. 62/169,152, the entire disclosure of which is hereby expressly incorporated by reference.

### BACKGROUND

A repurchase agreement (or repo) transaction is a sale of securities coupled with an agreement to repurchase the securities at a specified price on a later date. A repo transaction is economically similar to a secured loan. Repo transactions usually involve borrowers selling securities (loan collateral) to lenders for cash today, with the understanding that the transaction is reversed on a specified end date. Repo transactions are often conducted on an overnight basis. “Term repo” transactions are held for a specific term, e.g., 1-week, 2-weeks, 1 month, etc. Borrowers that enter a repo transaction have “repoed out” the securities; lenders conduct “reverse repo” transactions. Repo trades are often collateralized by U.S. Treasury securities but may be secured by other mutually agreed collateral. At least $5 trillion (USD) is repoed daily in the U.S. with perhaps another [symbol] 6.4 trillion (EUR) in Europe.

A bilateral repo transaction is a transaction between two parties that involves an assumption of credit risk by one party with respect to the other. The cash lender loans cash to a borrower and receives the borrower's securities as collateral. The proceeds of the initial securities sale can be thought of as the principal amount of the loan, and the excess paid by the cash borrower to repurchase the securities corresponds with the interest paid on the loan, also known as the repo rate. The difference between the amount of cash loaned and the value of the collateral posted is called the “haircut.” The haircut functions as a buffer for the lender against short-term variations in the value of the collateral. The haircut may also provide some protection against default.

Tri-party repo transactions are similar to bilateral repo transactions, but a third party, the tri-party agent, participates in the transaction along with the cash borrower and the cash lender or investor. Cash lenders, often money market mutual funds, have cash that they are willing to lend against collateral via the tri-party agent. Cash borrowers, often hedge funds, seek to finance securities that can be used as collateral. Cash lenders use tri-party repos as investments that offer liquidity maximization, principal protection, and a small positive return, while cash borrowers rely on them as a major source of short-term funding. The tri-party agent facilitates transactions by providing operational services, such as custody of securities, settlement of cash and securities, valuation of collateral, and optimization tools to allocate collateral efficiently. In the U.S. market, government securities clearing banks serve as tri-party agents. Tri-party repo transactions usually settle on the books of one of two “Clearing Banks” in the U.S. market: Bank of New York Mellon (BNYM) and JP Morgan Chase (JPMC). The clearing bank, or custodian bank, is thus a third party involved in the repo transaction between the borrower (e.g., party borrowing cash against securities collateral) and a cash investor or other lender (e.g., party lending cash against securities collateral. In practice, each of the borrower and the lender is represented by a respective dealer (e.g., broker-dealer) authorized to act as a clearing member with one of the two Clearing Banks. The clients of the broker-dealers thus do not deal directly with the Clearing Banks.

The custodian services of the custodian banks provide protections that do not exist for bilateral repo investors or unsecured creditors. The tri-party repo structure developed in response to the desire by cash investors to have collateral held by a third-party agent. The collateral used to secure tri-party repos consists largely of U.S. Treasuries and agency mortgage-backed securities and debentures. As of the first quarter of 2010, these types of collateral represented slightly more than 80 percent of all collateral in the tri-party market. Other assets financed through tri-party repos include fixed-income securities and equities on deposit at the Depository Trust & Clearing Corporation (DTCC) as well as whole loans (currently less than one percent of assets financed). These asset types are primarily, but not exclusively, investment-grade securities. Some are materially less liquid than traditional government and agency securities.

In a typical overnight tri-party repo transaction, a cash lender and a cash borrower arrange their tri-party repo transactions bilaterally in the morning, agreeing on the tenor of the repo, the amount of cash provided, the value of the collateral provided, and the repo rate, among other parameters. The actual securities used as collateral are assigned later by the tri-party agent (or, in some cases, by the cash borrower), such that the securities meet the schedule of acceptable collateral specified by the cash lender. After the terms of the transaction are agreed upon, the dealer notifies the custodian bank. In some cases, only the very basic terms of the repo are communicated.

Late in the day, the custodian bank, adhering to the terms of the transaction provided by the borrower, settles the repos by simultaneously transferring collateral and cash between the borrower's and lender's cash and securities accounts at the custodian bank. In other words, securities are moved from the borrower's securities account to the lender's securities account and the corresponding cash amounts are transferred from the lender's cash account to the borrower's cash account. This process “locks” the borrower's securities in the lender's account. A dealer often allocates specific securities to each transaction using its clearing bank's or its own collateral optimization engine, as constrained by the schedule of acceptable collateral. Overnight, the lender holds the collateral, which exceeds the value of the cash loan by the value of the haircut, to offset the risk that the borrower will not be able to return the appropriate amount of cash the following day.

At 3:30 p.m. each day, the custodian bank extends credit to each dealer and returns the securities that were pledged as collateral so that the dealer can deliver any securities that are sold to buyers. This process of returning the collateral to the dealer is referred to as “unwinding” the repo. In overnight repo transactions, the unwinding each afternoon creates an overdraft in the dealer's cash account at its custodian bank when the custodian bank returns the repo collateral to the dealer and returns the cash borrowed by the dealer to the lender's demand deposit account.

Throughout the business day, broker-dealers buy, sell, and finance securities for their own and their client-owned positions. These securities may be delivered into and out of the dealer's securities account at its custodian bank. Either way, dealers typically do not have sufficient cash balances at their custodian bank to pay for their securities purchases during the day. Dealers use the cash they receive from lenders at the end of the day to extinguish these overdrafts.

### BRIEF DESCRIPTION OF THE DRAWINGS

FIG. 1 depicts a schematic representation of an exemplary repo transaction involving one or more aspects of a clearing technique as described herein.

FIG. 2 depicts a flow chart showing one embodiment of a data structure management method in connection with a repo clearing.

FIG. 3 depicts a flow chart showing default management and processing procedures of the disclosed method in accordance with one embodiment.

FIG. 4 depicts a block diagram one embodiment of a data structure management system configured for use in connection with a repo clearing in accordance with one or more aspects of the disclosure.

FIG. 5 depicts a block diagram showing another embodiment of a data structure management system configured for use in connection with a repo clearing in accordance with one or more aspects of the disclosure.

FIG. 6 shows an illustrative embodiment of a general computer system for implementing one or both of the methods of FIGS. 2 and 3, and/or for use with one or both of the systems of FIGS. 4 and 5.

FIG. 7 depicts a block diagram of an exemplary exchange system and framework for implementing one or more of the disclosed methods and/or for use with one or more of the disclosed systems.

### DETAILED DESCRIPTION

One or more aspects of the disclosure are directed to data structure management to (1) support effective risk management practices at a clearing house that are not overly burdensome to broker-dealers and other brokering market participants, and/or (2) establish orderly liquidation procedures upon default of a participant in tri-party repo and other markets. The disclosed data structure management methods and systems may lead to lowered or minimized loss risks for broker-dealers or other brokering market participants, while also lowering the risk of loss for a clearing house that clears tri-party repo and other transactions. In so doing, the disclosed data structure management methods and systems may additionally establish an operational framework or procedural arrangement for liquidation of assets in the event of a default of a market participant.

Described herein are data structure management methods and systems directed to clearing repo and other transactions. The methods and systems may establish or utilize a hybrid model or framework for clearing in which the end users for repo transactions (i.e., the borrowing and lending market participants) have a direct relationship with a clearing house as a counterparty to cleared repo (or other) transactions. The model can be applied to other types of transactions. Under one example of the hybrid framework, each such direct end user participant may settle all aspects of the cleared repo transaction submitted to the clearing house directly with the clearing house, but is also obligated to be qualified by a clearing member who represents such participant's activity in the clearing house's mutualized guaranty fund. The model may thus be considered a hybrid of the principal clearing approach and the agency clearing approach. In the principal model, there are only principals involved in the clearing transaction workflow. In the pure agency model, clearing members intermediate every aspect of the clearing workflow for undisclosed customers.

In the hybrid clearing model, and as described herein, the end users and the clearing house may settle securities and cash positions directly with each other. As a result, the clearing members of the customers are not responsible for settling the “on” and “off” leg transactions arising from a repo transaction. Instead, the end users and the clearing house exchange amounts involved in transaction settlement directly with each other. For example, the end users and the clearing house may exchange settlement amounts. The clearing members remain obligated to post the initial margin for the repo transaction. The clearing members may have additional obligations or responsibilities, including, for example, making guaranty fund contributions (e.g., on behalf of their customers).

Although described herein in connection with repo transactions, the disclosed embodiments are well suited for use with other types of transactions and financial instruments. For example, transactions such as Delivery Versus Payment (DVP) transactions (or Receive Versus Payment, or RVP, transactions) may be cleared using the hybrid clearing model of the disclosed embodiments. DVP transactions involve a settlement procedure in which a buyer's payment for securities is due at the time of delivery. The DVP transaction stipulates that cash payment is to be made prior to, or simultaneously with, the delivery of the security. The DVP transaction reduces exposure to principal risk associated with the settlement date by ensuring that payments accompany deliveries. DVP transactions may be implemented via a system that acts as a link between a funds transfer system and a securities transfer system.

The clearing house may be an adjunct to an exchange responsible for settling trading accounts, clearing trades, collecting and maintaining performance bond funds, regulating delivery and reporting trading data. Clearing is the procedure through which the clearing house becomes buyer to each seller of an instrument, and seller to each buyer, and assumes responsibility for protecting buyers and sellers from financial loss by assuring performance on each contract. This is effected through the clearing process.

The clearing house establishes clearing level margins for the transactions and establishes minimum margin requirements for customers of the financial products. A margin corresponds with the funds that must be deposited by a customer for the purpose of insuring the clearing house against loss on the transaction. This is not a part payment on a purchase. The margin helps to ensure the financial integrity of the clearing house. An initial margin is the total amount of margin per transaction required by the clearing house when a transaction occurs.

The clearing house derives its financial stability in large part by removing debt obligations among market participants as they occur. This is accomplished by “marking to market” on a daily basis. Every transaction is debited or credited based on that day's gains or losses. As prices move for or against a transaction, the clearing house pays to or collects cash from each participant. This cash flow, known as settlement variation, is performed based on instructions issued by the clearing house. When a participant owes money to the clearing house in connection with settlement variation, the amount may be referred to as “variation margin.” In times of extreme price volatility, the Clearing House has the authority to perform additional mark-to-the-market calculations on open positions and to call for immediate payment of settlement variation.

If a clearing member does not have sufficient performance bond collateral on deposit with the Clearing House, then the clearing member must meet a call for cash performance bond deposits.

A margin requirement thus often has two components, an initial margin and a variation (or settlement) margin. The initial margin attempts to cover potential future losses arising from changes in the interest rate. The variation margin captures losses or gains that have already occurred. The variation margin thus provides traders with a daily settlement mechanism to account for changes in the market for the contract.

A dealer in the over-the-counter (OTC) repo market may have capital charges reflecting the full notional value of all repo transactions that they enter into with third parties even when such transactions result in a net “flat” position. A dealer firm also acting as a clearing member for customers in a pure agency model of clearing may similarly be responsible for the full notional exposures with respect to their customers.

This results from clearing members in a pure agency clearing model being potentially responsible for settlement of transactions on a trade-by-trade basis. Therefore, such clearing members may be forced to reflect that potential liability on balance sheets. The potential liabilities can be compounded for dealers representing multiple parties in different OTC repo transactions even though the nature of the transactions may be offsetting (e.g., borrowing in some cases and lending in other cases).

The disclosed embodiments provide a framework for addressing challenges that these dealer firms may face when facilitating repo transactions in OTC markets. The framework creates a new model of direct data and transaction flow between a clearing house and the end users for repo transactions, in which such end users are ultimately represented by a clearing member in the mutualized financial safeguards but such clearing member is not responsible for such end user customer in the day to day transaction flows. This data flow is a hybrid clearing model in which both clearing members and their customers, i.e., the parties to repo transactions (e.g., the cash borrower and the cash lender), are responsible for certain aspects of the cleared repo transaction. In the hybrid framework, the clearing house relies upon contractual relationships with both the clearing members and the underlying repo transaction parties represented by the clearing members.

In some cases, the clearing house maintains account data structures for parties clearing repo transactions, such as collateral and margin account data structures. Because market participants are responsible for settling transactions directly with the clearing house, the clearing members that represent such market participants do not provide a full guarantee for the exposure resulting from the transaction. The market participants are therefore direct counterparties to the clearing house for cleared repo transactions. The clearing member acting on behalf of the market participant therefore does not have any direct responsibility for ensuring that the customer performs in connection with settlement of the transaction. Clearing members may accordingly be relieved of the duty to record or report the full notional amount of the repo transaction as a potential liability (e.g., on a balance sheet). The framework may also allow “dealers” in the repo markets to act as self-clearing members and submit matched trades as principals. In other cases, the clearing members are responsible for the initial margin, but are still not responsible for whether the customer performs in connection with settlement of the transaction. Clearing members may thus still be relieved of the duty to record or report the full notional amount of the repo transaction as a potential liability.

The disclosed embodiments may thus provide a new clearing technique that allows non-dealer market participants to submit trades they have entered over the counter (OTC) as counterparties directly with a new clearing house, provided that the market participants have a clearing member (e.g., clearing firm) represent them as an agent for these trades and act as a guarantor in certain default scenarios, although not on settlement.

The disclosed framework differs from other arrangements in which, for instance, repo transactions are done OTC directly between counterparties, with each counterparty being responsible to the other as a principal. The framework also differs from cleared repo transactions in which dealer firms that are clearing members (at, e.g., the Fixed Income Clearing Corporation, or FICC) deal with FICC in a principal capacity. The framework also differs from arrangements in, for instance, futures trading, in which clearing members instead act as full guarantors for all aspects of the customer trades, including settlement.

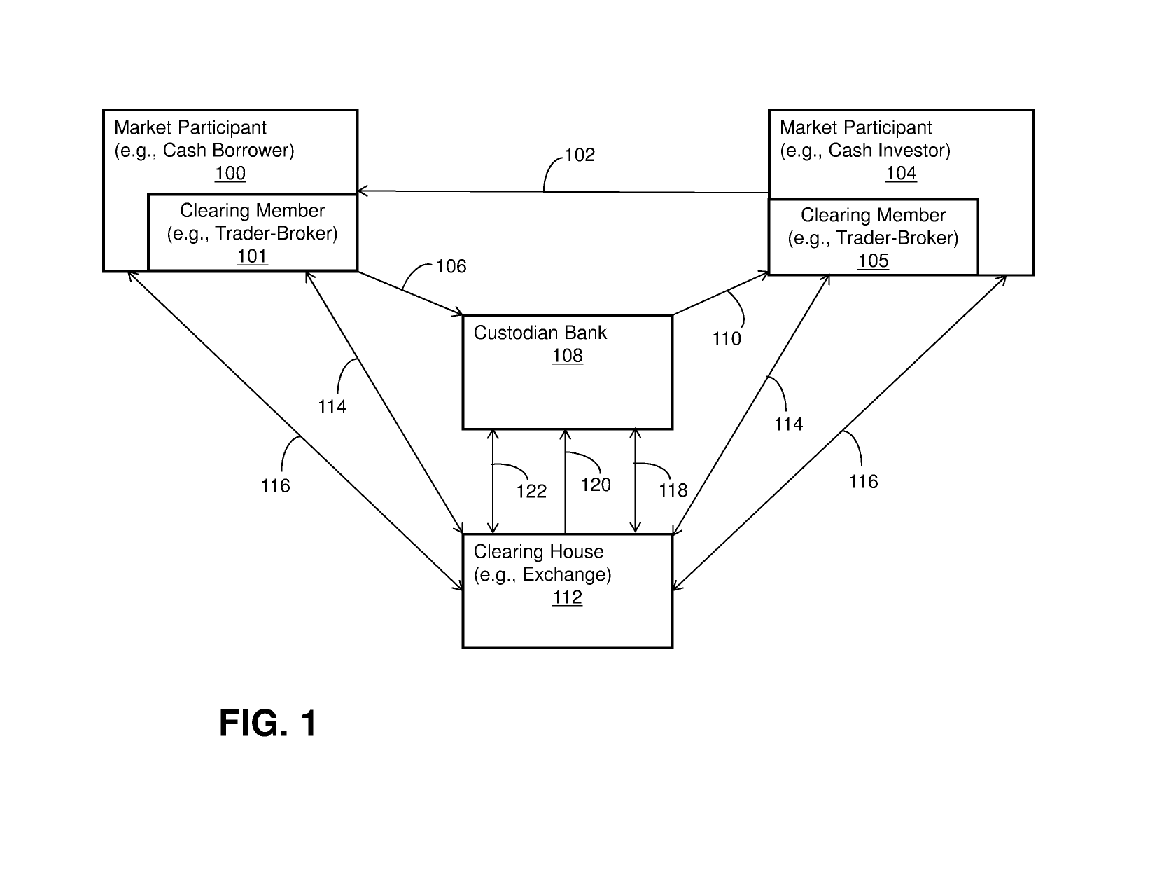

With reference now to FIG. 1, in a tri-party repo transaction, a market participant 100 (e.g., a cash borrower, such as a hedge fund) borrows cash 102 for a short period from another market participant 104 (e.g., a cash lender, such as a money market fund), acting as a repo investor or counterparty. The borrowing market participant 100 pledges securities 106 as collateral for the loan. The collateral may be held by a custodian bank 108, which acts as a tri-party agent. The custodian bank 108 accordingly provides the lending market participant 104 with rights 110 to the collateral under a repo transaction agreement. Investors with large cash balances and/or large portfolios of securities can thus lend these out and earn a return over time. In a tri-party repo transaction, both parties 100, 104 to the repo transaction may have cash and collateral accounts at the custodian bank 108, which may also be or include a clearing bank. The custodian bank 108 may ensure that the collateral pledged is sufficient and meets eligibility requirements, and both counterparties 100, 104 to the transaction agree to use collateral prices supplied by the custodian bank 108.

To further support the transaction and lower risk of loss, the repo transaction is cleared by a clearing house 112, which may be a securities clearing agency. As part of the clearing process, margin requirements are incorporated into the tri-party repo transaction. The margin requirements include both initial margin requirements and variation margin requirements, as described above.

To implement the clearing process, the clearing house 112 has relationships with a number of dealers. Each dealer is authorized to act as a clearing member. Each clearing member acts on behalf of, or represents, a market participant. In this example, a clearing member 101 represents the borrowing market participant 100, and a clearing member 105 represents the lending market participant 104. In a typical agency-clearing model, each of the clearing members 101, 105 is independently responsible to the clearing house 112 for the full notional value of a transaction that the clearing member clears at the clearing house. In that model, the clearing house 112 thus requires each of the clearing members 101, 105 to post a margin to cover both the initial margin requirement and the variation margin requirement.

In the hybrid model of the disclosed embodiments, both the clearing members 101, 105 and the market participants 100, 104 (who are direct counterparties to the clearing house) have roles and responsibilities in connection with clearing. A relationship 114 between the clearing house 112 and the clearing members 101, 105 is defined such that the clearing members 101, 105 are responsible for making guaranty fund contributions on behalf of their customers. A relationship 116 between the clearing house 112 and the market participants is defined such that the market participants 100, 104, rather than the clearing members 101, 105, are responsible for making settlement with the clearing house for cleared repo transactions as direct counterparties. The settlement may involve posting requisite levels of collateral, or direct variation margin, throughout the term of the repo transaction. Thus, the market participants are solely responsible for all aspects of the settlement of transactions of the market participant 100, 104 directly. The relationship 116 between the clearing house 112 and the market participants 100, 104 is also structured such that the clearing house 112 may have rights 118 to the collateral held by the custodian bank 108 (e.g., in certain circumstances). The clearing house 112 may determine, or help determine, the amount or data level of the collateral and/or other terms of the repo transaction by providing instructions 120 to the custodian bank 108. As a result of these relationships, the clearing members 101, 105 are not responsible for settlement of the full notional value of the cleared repo transactions, as under the typical agency-clearing model. Instead, the clearing members 101, 105 are responsible for contributing to a guaranty fund in support of the market participants 100, 104, as described below. In some cases, the market participants 100, 104 are also responsible for posting the initial margin for the transaction. In other examples, the clearing members 101, 105 are responsible for collecting and posting the initial margin from their customers.

Although described herein in the context of cash loans in which an investor places its money with the custodian bank 108, which in turn lends the money to another institution, practice of the disclosed methods and systems is not limited to cash loans. Non-cash assets may be loaned to the borrowing market participant 100 in some embodiments. Other assets owned by the borrowing market participant 100 may then be pledged as collateral for the loan. Such non-cash loans may be useful for market participants interested in obtaining, for instance, scarce assets for a temporary period. Further details regarding collateralized lending procedures and systems to support such non-cash loans, including so-called General Repo Futures (GRF) and Special Repo Futures (SRF), are described in U.S. Patent Publication No. 2010/0169205 (“Collateralized Lending Using a Central Counterparty”), the entire disclosure of which is incorporated by reference. To support such non-cash loans and/or other aspects of the transactions described herein, the custodian bank 108 may be a part of, or otherwise affiliated with another financial institution, such as an Exchange.

Data 122 indicative of the details of the tri-party repo transaction may be transmitted 122 by the custodian bank 108 (and/or other parties) to the clearing house 112. The transmission may occur one or more times per day, on a regular, scheduled, or other basis. The data 122 may be received by the clearing house 112 to determine, for instance, the margin requirements, the collateral amount or data level, the guaranty fund contribution data level, or other terms of the transaction, including whether an adjustment to the margin requirement is warranted.

Several of the benefits of the disclosed methods and systems relate to addressing a default of one of the market participants 100, 104. The default may occur in connection with either side of the cleared repo transaction. The relationships between the above-described entities may accordingly establish default procedures in the event of default by one of the market participants 100, 104. The default procedures may involve a number of steps taken by the clearing house 112 to cover any losses. The default procedures may also involve seizure by the clearing house 112 of the initial margins. If losses are still outstanding, one or more loss recovery procedures may be implemented by the clearing house 112, including, for instance, seizure of one or more party's contributions to one or more guaranty funds. In some cases, guaranty funds may be established for market participants and/or clearing members. Contributions to the guaranty fund(s) may be a prerequisite to participation in repo transactions involving the clearing house 112.

For these and other reasons, implementation of the disclosed methods and systems may benefit a number of parties involved either directly or indirectly in the repo transactions. For example, the clearing members 101, 105 of the clearing house 112 may benefit from not having to acknowledge liabilities associated with the full notional amount at risk in the repo transaction. The custodian bank 108 may also benefit from the disclosed methods and systems via by offering the market participants (e.g., the borrowers and lenders) improved repo custodian service, including the potential for lower interest rates, haircuts, or collateral amounts. The lower costs, in turn, also benefit the market participants. The clearing house 112 may benefit from the disclosed methods and systems in a number of ways, including, for instance, increased capital efficiencies for clearing members 112. All of the parties involved in the transaction may benefit from the disclosed methods and systems via the additional layer of potential protection provided by the clearing house 112 and the potential for gain and/or loss sharing in the event of a default.

The disclosed embodiments provide improvements in the data processing of repo and other cleared transactions in which the market participants are not direct counterparties to the clearing house. For instance, at least some of the processing and transmission of the data indicative of the transaction does not involve intermediary computing systems, such as those at clearing members. Efficiencies in computing resources, such as processing, memory, and network communication resources, can thus be realized. For example, in the hybrid clearing model, the lack of intermediation by the clearing members may remove the duplication of margin-related data processing at the clearing members. The hybrid clearing model instead allows the clearing house, or exchange, computer system to handle the margin-related data processing alone, because the market participants, rather than the clearing members, are solely responsible for initial margins, variation margins, and ultimate settlement. Without the need to record such margin-related data, the clearing member computer system has reduced memory requirements, and the data structures in the clearing system computer memory are simplified. Furthermore, the clearing member computing systems may avoid any related data processing for the account books and associated regulatory compliance.

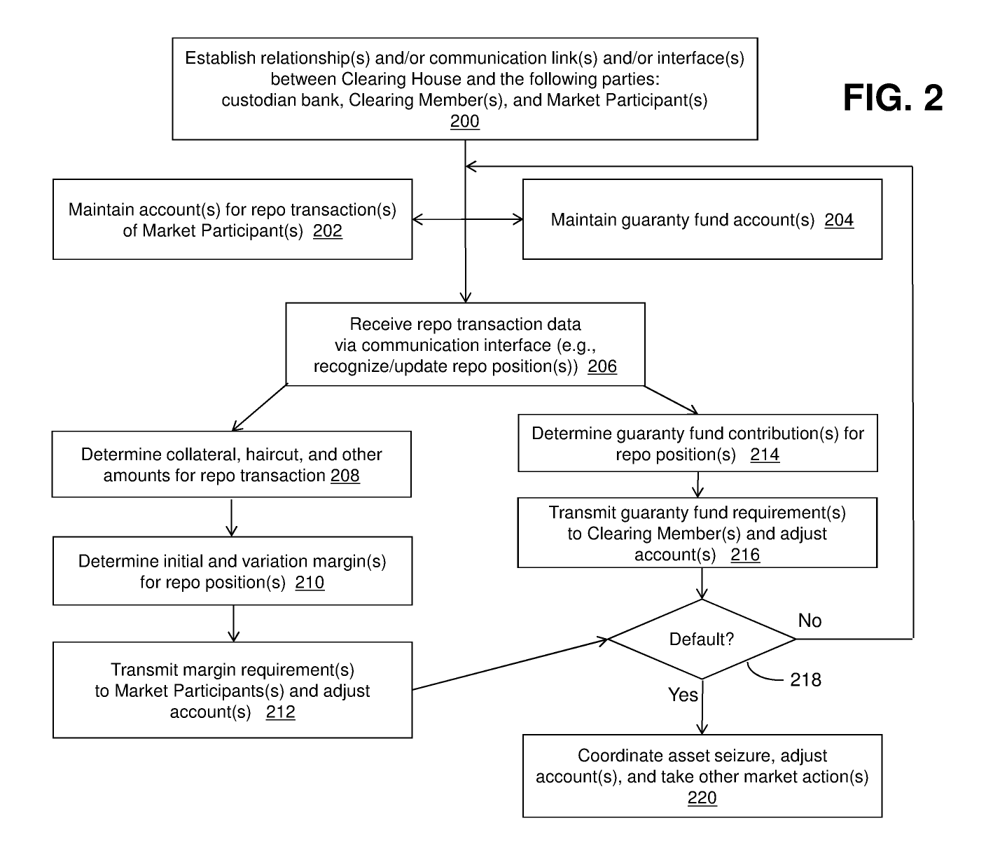

FIG. 2 depicts a computer implemented data structure management method configured to implement data transactions relating to a repo transaction, such as a tri-party repo transaction. The method may begin with establishing one or more data structures indicative of relationships with a clearing house (block 200). Relationships may be established between the clearing house and one or more market participants, one or more clearing members, and/or a custodian bank. The relationship data structure(s) may specify a variety of parameters and/or aspects of a framework in which the repo transaction is implemented in accordance with the disclosure, including parameters for one or more cleared repo transactions thereof, one or more exchange transactions thereof, margining and other rules, and liquidation procedures. The relationship(s) may thus include a contractual relationship between the exchange and one or more entities to establish the clearing model described herein. The contractual relationship may establish one or more agency relationships between the exchange and the custodian bank. Such agency relationships may, for instance, be utilized in connection with the handling of collateral. The relationship may identify the custodian bank as a tri party repo agent for the transaction, and specify various other parameters of the repo transaction (e.g., collateral asset type, collateral asset value, interest rate, haircut, delivery date, term, etc.).

The relationship is not limited to specifying contractual or transactional parameters. The relationship may establish one or more communication links or interfaces between the exchange and the other entities. The communication interface may facilitate the transmission and reception of data reflective of the repo transaction in accordance with the disclosed methods and systems.

One or more processors associated with the clearing house maintain (e.g., automatically maintain via, for instance, a processor) an account data structure for one or more market participants (block 202) and a guaranty fund data structure in which guaranty fund contributions are made by a clearing member on behalf of the market participant(s) (block 204). The accounts are used to reflect (e.g., store data relating to) activity in connection with one or more repo transaction(s) submitted by the market participant and cleared by the clearing house. Maintenance of the accounts may precede, be concurrent with, or follow the establishment of the relationship between the clearing house and one or more other entities, such as the custodian bank. The account(s) is/are maintained separately from custodian bank accounts associated with the custodian bank.

With the communication interface and other aspects of the relationship established, data may be transferred between the exchange, the custodian bank, and other parties involved in the repo transaction. The data transfer may occur at any time relative to the net exchange position determination. In the depicted embodiment, data reflective of or otherwise regarding the repo transaction is received by the clearing house (block 206). The data may specify the repo transactions submitted by one or both of the market participants. The repo positions for each market participant may thus be recognized and/or updated. The data may specify a number of other parameters regarding the transaction, including parameters directed to the collateral provided by the market participant in support of the loan position. For example, the type of asset used for the collateral and the market value of the collateral may be specified. However, in the example of FIG. 2, the collateral, haircut, and other amounts or data levels for the repo transaction are determined by the clearing house (block 208). In such cases, one or more of the parameters for the repo transaction are then communicated to the custodian bank.

The data reflective of the repo transaction may be processed to determine the initial margin and variation margin data levels for one or both of the repo positions (block 210). The initial and variation margin requirements or data levels for the repo position are determined (e.g., automatically determined) based on the data received via the communication interface. Once the initial and variation margin data levels are determined, data indicative of the initial and variation margin(s) may then be transmitted to the market participants (block 212). At that point or a later point (e.g., when the market participant transfers funds to cover the initial margin requirement), the account(s) of the market participants(s) are adjusted (e.g., automatically adjusted) to reflect the initial and variation margin requirements or data levels.

The variation margin data levels are determined (e.g., automatically determined) for one or both of the repo positions either concurrently with, before, or after the initial margin determination. The variation margin determination may be based on the received repo transaction data, which may include market data reflecting changes in, for instance, the value of the collateral or other repo position. As the variation margin data level(s) are updated, data indicative of the variation margin requirement(s) or data level(s) is transmitted to the market participant(s) (block 212). At that point or a later point (e.g., when the market participant transfers funds to cover the variation margin requirement), the account(s) of the market participant(s) are adjusted (e.g., automatically adjusted) to reflect the variation margin requirement or data level.

The data reflective of the repo transaction may be processed to determine the guaranty fund contribution requirement(s) or data level(s) for one or both of the repo positions (block 214). The guaranty fund data levels are determined (e.g., automatically determined) based on the data received via the communication interface. Once the guaranty fund contribution data levels are determined, data indicative of the guaranty fund contribution data levels may then be transmitted to the clearing members (block 216). At that point or a later point (e.g., when the clearing member transfers funds to contribute to the guaranty fund), the guaranty fund data structures(s) are adjusted (e.g., automatically adjusted) to reflect the guaranty fund contribution data levels.

At any time, such as after the margin requirement determination, control may pass to a decision block 218 configured to detect a default by a market participant. The default may involve a failure to deliver the borrowed cash, the security, or both. The circumstances under which a default is declared may vary. For example, in some cases, failure to deliver a bond may not be deemed a default. A penalty charge may instead be assessed in such cases. The detection of a default may include data transfer via the communication interface. For example, a processor of the clearing house may transmit a request to the custodian bank to inquire into the status of the repo transaction. Alternatively or additionally, a processor of the custodian bank may transmit an alert or other status update regarding the cleared repo transaction. Such data transfers may occur in various automated ways, e.g., regularly and/or be triggered by predetermined events. If the market participant has not defaulted, then control may return to the procedures directed to general account maintenance (e.g., blocks 202, 204). If, however, a market participant has failed to return the cash or other asset as required via the tri-party repo transaction, then one or more processors of the clearing house and the custodian bank coordinate (e.g., automatically implement) seizure of assets identified in the accounts and, in some cases, liquidation of the assets (block 220), including, for instance, liquidation of the collateral. Such liquidation may further include liquidation of other positions of the market participant maintained via the exchange and custodial accounts at the Exchange and custodian bank, respectively.

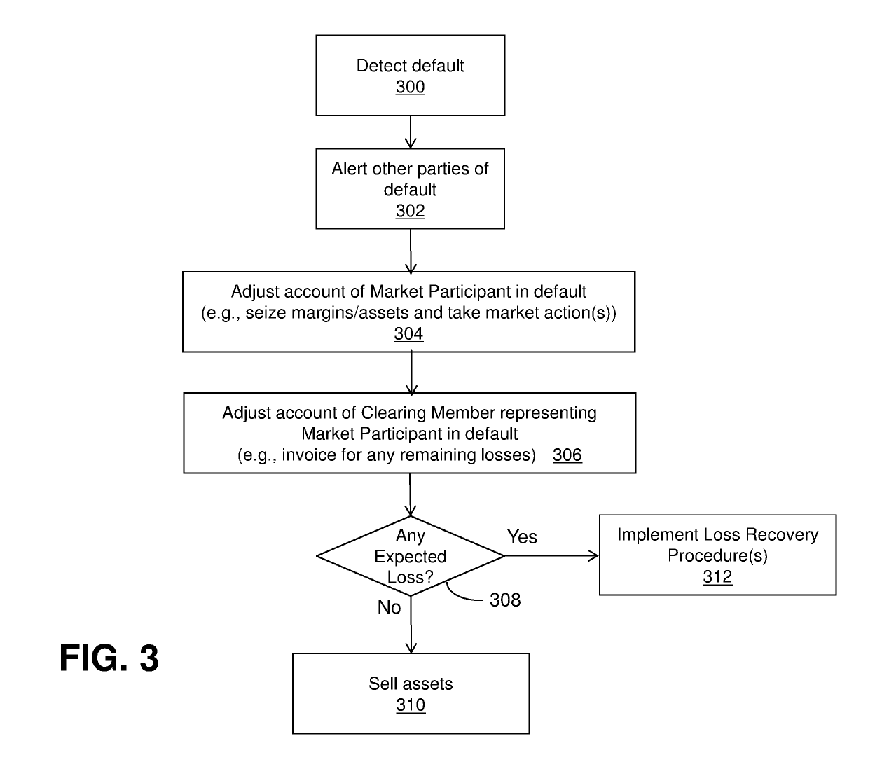

FIG. 3 depicts an exemplary data structure management method configured to manage or process a default in accordance with one embodiment. The method includes detecting a default by the market participant (block 300), which is followed by an alert or other communication from the clearing house to the custodian bank, or vice versa (block 302). The account of the market participant in default is then adjusted (e.g., automatically adjusted) in accordance with the default procedure (block 304). The adjustment may reflect the loss of any margin, collateral or other assets of the market participant that are accessible by the clearing house. The procedure may thus involve seizure of any assets or other holdings listed in the account associated with the repo transaction. Liquidation of the assets or other holdings of the market participant may then be implemented by the clearing house. The clearing house may also take other market actions to reduce the risk associated with the defaulting market participant's repo transactions including, for example, entering into new offsetting repo transactions or coordinating market auctions for the same purpose. The default management procedures and the coordination of the timing and other aspects thereof may vary.

In the example of FIG. 3, the default procedure also includes the adjustment (e.g., automatic adjustment) of an account of the clearing member representing the market participant in default (block 306). The adjustment may reflect an invoice for any remaining losses after implementation of the market actions associated with the positions held by the market participant in default. Each clearing member may be invoiced to pay for a loss associated with a market participant represented by the clearing member. In some cases, the payment can be made via a payer contract mechanism in which money is moved between accounts of traders through a riskless position value and settlement value defined by a payer contract. Further details regarding the construction, application, implementation, and other characteristics of payer contracts are described in U.S. Patent Publication No. 2012/0323764 (“Facilitation of Payments between Counterparties by a Central Counterparty”), the entire disclosure of which is hereby incorporated by reference. Payer contracts or, in some cases, one side thereof, may be used to effectuate any transfer of funds involved in the hybrid clearing framework described herein. For instance, transfers involving the initial margin, variation margin, or guaranty fund, may be implemented via the payer contract technique.

In the example of FIG. 3, the method also includes a determination (e.g., automatic determination) by one or more processors of the clearing house and/or custodian bank as to whether a loss is expected after the market actions and invoicing of the clearing member (block 308). If not, the clearing house and/or the custodian bank may proceed (e.g., automatically proceed) with the asset sales or other market actions, to the extent such actions are not already complete (block 310).

If a loss is expected, then one or more loss recovery procedures may be implemented by the clearing house (block 312). The loss recovery procedures may include accessing (e.g., automatically assessing) one or more guaranty funds. For example, clearing members may be obligated to contribute to a clearing member guaranty fund, the funds being accessible in the event of a clearing member default. Alternatively or additionally, each market participant may be required to contribute to a market participant guaranty fund. The extent to which the guaranty fund(s) are depleted to cover losses may vary. For example, in some cases, the respective contribution is accessed through depletion, at which point the other contributions may be accessed. Additional, alternative, or fewer loss recovery procedures may be provided.

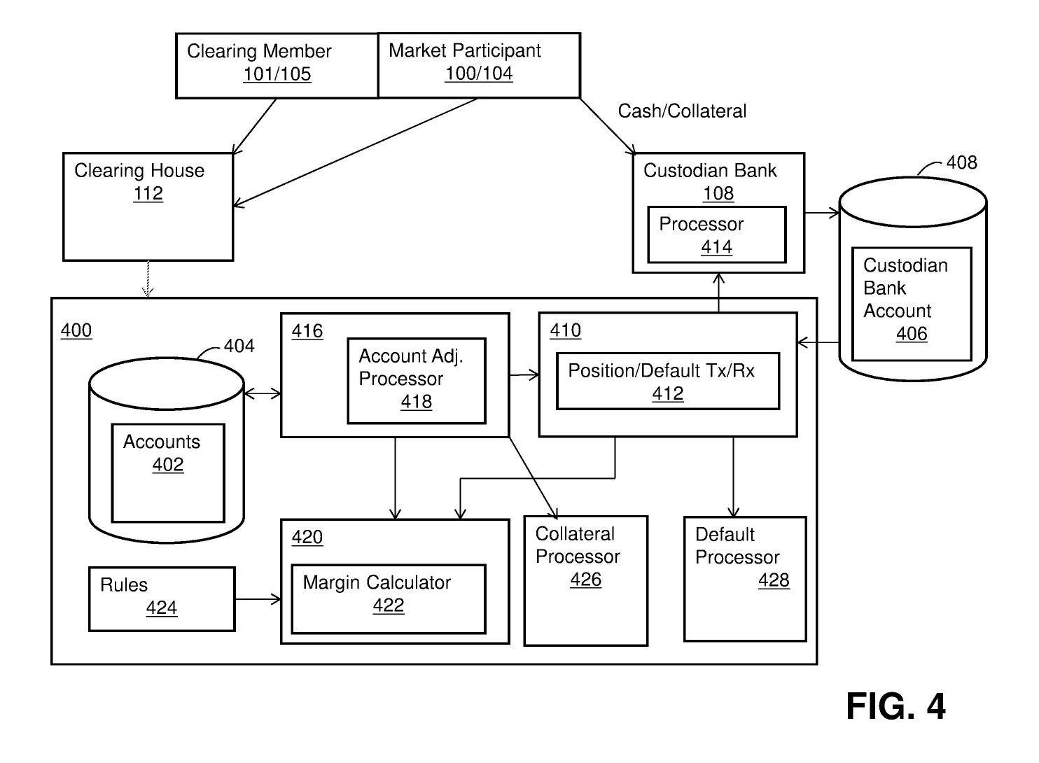

With reference to FIG. 4, where elements in common with other figures are indicated via common reference numerals, a data structure management system 400 for implementing data transactions related to clearing a repo transaction in accordance with one embodiment is depicted. The system 400 may be used to implement any of the methods described herein. The market participant(s) 100, 104 enter(s) into one or more repo transactions with the custodian bank 108, offering up either cash or collateral in connection therewith. One or both sides of the repo transaction are cleared by the clearing house 112 via the representation of one of the clearing members 101, 105.

The system 400 maintains account or other data structures 402 for one or both market participants 100, 104 and one or both clearing members 101, 105. In the example of FIG. 4, data representative of the accounts 402 is stored in a database 404. Multiple databases or other data stores may be used. The accounts 402 are maintained separately from accounts 406 of the custodian bank 108 disposed in a database 408.

The system 400 includes a communication interface processor 410 configured to receive data reflective of the repo transaction via a communication interface configured for communications via a network. The data may be provided by the custodian bank and/or the other entities involved in the repo transaction. In this example, the communication interface processor 410 includes a transceiver 412 configured for data transfers relating to the repo position and/or default by the market participant. The transceiver 412 may have transmitter and receiver components integrated to any desired extent. For example, the transceiver 412 may be configured to transmit and/or receive data packets indicative of the repo position. The transceiver 412 may also transmit and/or receive instructions, messages, or other communications regarding default. The data and other information received by the transceiver 412 may be generated by one or more processors 414 of the custodian bank 108. The processor(s) 414 may also be configured to receive data and information from the system 400 via the communication interface processor 410.

Data indicative of the repo transaction may be processed by an account maintenance processor 416 of the system 400. The account maintenance processor 416 is configured to maintain a market participant account data structure for the market participant (e.g., a margin account data structure for the market participant) and a guaranty fund data structure for the clearing member representing the market participant. The account maintenance processor 416 may include a database management system or other system for handling queries to the database 404. Alternatively or additionally, the account maintenance processor 416 includes an account adjustment processor 418 configured to determine adjustments to the account or other data structures of the market participant(s) and the clearing member(s) based on received data. For instance, the account maintenance processor 416 and/or the account adjustment processor 418 may handle any adjustments to the accounts as a result of margin changes and/or defaults. The account maintenance processor 416 may be coupled to the communication interface processor 410 to support transmission or reception of data related to the repo transactions and/or defaults.

The account maintenance processor 416 may also be coupled to a transaction processor 420 of the system 400 to receive data indicative of the margin requirement, guaranty fund, or other data levels. In this example, the transaction processor 420 is coupled to the communication interface processor 410 to receive data indicative of the repo position(s) to incorporate the repo transaction data from the database 408 into the margin requirement determination. The transaction processor 420 may include a margin calculator 422 configured to determine both initial margin requirements (or data levels) and variation margin requirements (or data levels). The transaction processor 420 and/or the margin calculator 422 determine an initial margin requirement or data level and a variation margin requirement or data level for the repo position and for which the market participant is responsible, as described above.

The system 400 may include data indicative of rules 424 for clearing, collateral, and/or default procedures.

In the example of FIG. 4, the system 400 includes a collateral processor 426 configured to determine a collateral amount or data level for the repo position and for which the market participant is responsible. In some cases, the collateral processor 426 is integrated to any desired extent with the transaction processor 420.

The system 400 also includes a default/liquidation processor 428 coupled with one or more of the above-described components of the system 400 and operative to implement seizure of assets, coordinate liquidation of the seized assets, or implement other market actions, upon detection of a default by the trader 100. The default processor 428 may be coupled with the communication interface processor 410 to transmit or receive data indicative of the default. The default processor 428 may also be integrated to any desired extent with the transaction processor 420.

The communication interface processor 410 and/or the transceiver 412 may also be configured to transmit, via the communication interface, data indicative of the determined collateral amount or data level, the determined initial margin requirement or data level, and the determined variation margin requirement or data level.

The account maintenance processor 416 and/or the account adjustment processor 418 are further configured to adjust the market participant account in accordance with the determined collateral amount or data level and the determined variation margin requirement or data level, and to adjust the margin account in accordance with the determined initial margin requirement or data level.

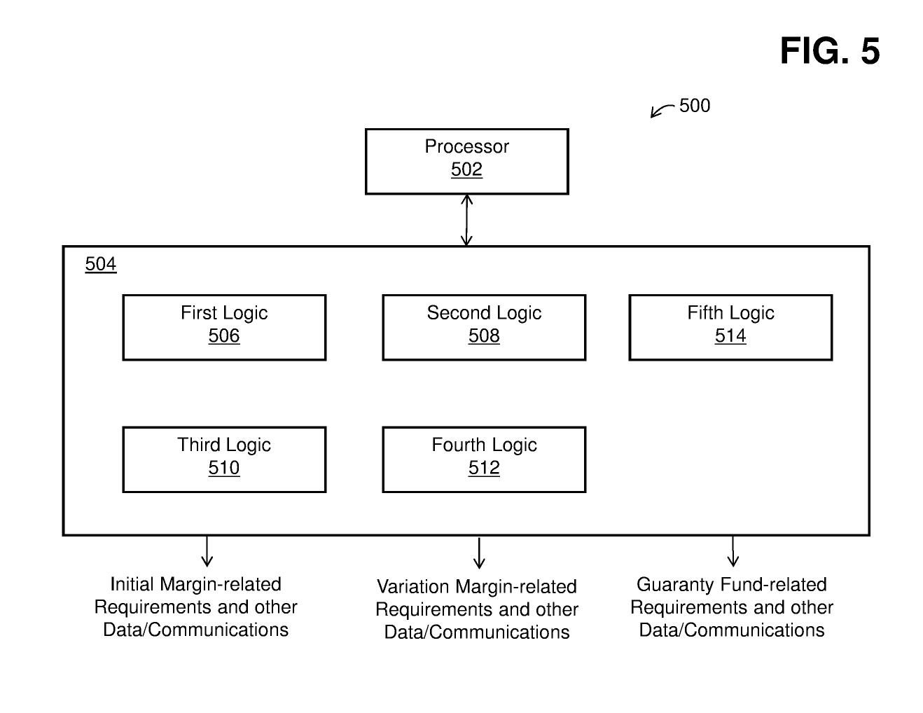

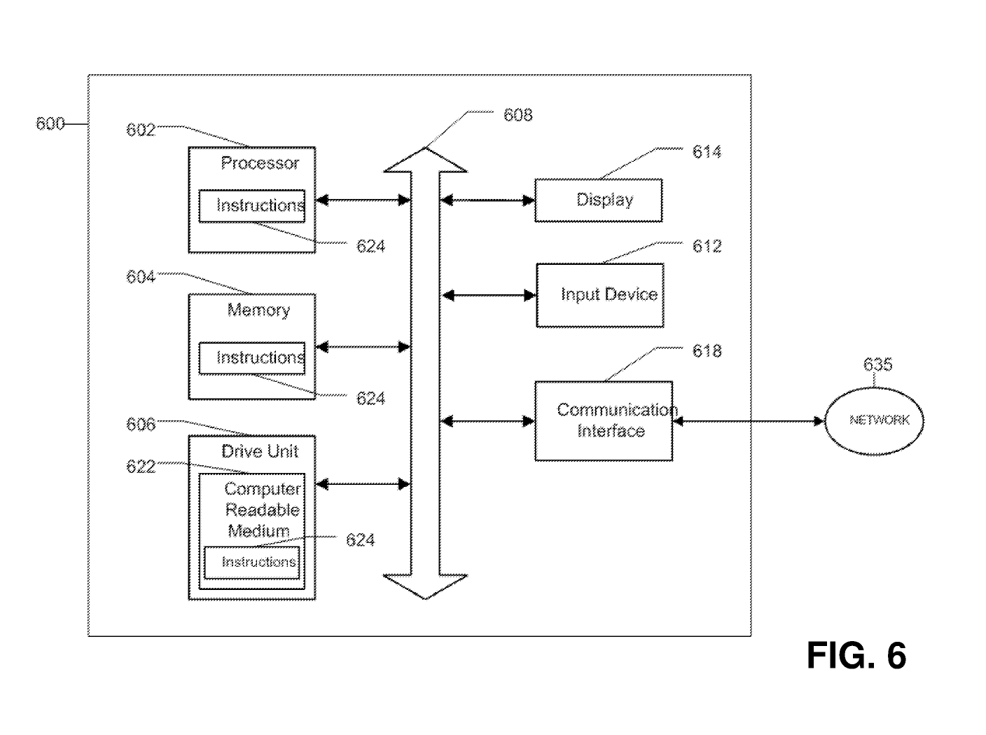

FIG. 5 depicts a data structure management system 500 for clearing a repo transaction in accordance with one embodiment. The system 500 may be configured to implement any one or more of the methods described herein. The system 500 includes a processor 502, which may correspond with or include any one or more of the above-described processors. The system 500 also includes a memory 504 coupled with the processor 502. The configuration of the memory 504 may vary, such that the memory 504 may include any number or combination of storage devices, data stores, databases, and memories. The memory 504 is configured for non-transitory storage of data and/or instructions directed to determining a margin requirement or data level as described herein. The memory 504 may store such data and/or instructions in a volatile and/or non-volatile manner. Further details regarding examples of the processor 502 and the memory 504 are described below in connection with FIG. 6.

The system 500 includes first logic 506 stored in the memory 504 and executable by the processor 502 to maintain a market participant account data structure for the market participant and to maintain a guaranty fund data structure for a clearing member representing the market participant. The system 500 includes second logic 508, coupled with the first logic 506, stored in the memory 504 and executable by the processor 502 to receive, via a communication interface configured for communications via a network, transaction data indicative of a repo position of the market participant for the repo transaction. The system 500 includes third logic 510 stored in the memory 504, executable by the processor 502, and coupled with the first logic 506 and the second logic 508 to determine, based on the received transaction data, an initial margin requirement or data level and a variation margin requirement or data level for the repo position and for which the market participant is responsible. The system 500 includes fourth logic 512 stored in the memory 504, executable by the processor 502, and coupled with the fourth logic 510 to adjust the market participant account in accordance with the determined variation margin requirement or data level and the determined initial margin requirement or data level. In some cases, the system 500 includes fifth logic 514 stored in the memory 504, executable by the processor 502, and coupled with the second logic 508 to determine a collateral amount or data level for the transaction.

Referring to FIG. 6, an illustrative embodiment of a general computer system 600 is shown. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. Any of the components discussed above may be a computer system 600 or a component in the computer system 600.

In a networked deployment, the computer system 600 may operate in the capacity of a server or as a client user computer in a client-server user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one or more embodiments, the memory 604 includes a cache or random access memory for the processor 602. In alternative embodiments, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions 612 stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 600 may further include a display unit 614, such as a liquid crystal display (LCD), an organic light emitting diode (OLED), a flat panel display, a solid state display, a cathode ray tube (CRT), a projector, a printer or other now known or later developed display device for outputting determined information. The display 614 may act as an interface for the user to see the functioning of the processor 602, or specifically as an interface with the software stored in the memory 604 or in the drive unit 606.

Additionally, the computer system 600 may include an input device 616 configured to allow a user to interact with any of the components of system 600. The input device 616 may be a number pad, a keyboard, or a cursor control device, such as a mouse, or a joystick, touch screen display, remote control or any other device operative to interact with the system 600.

In a particular embodiment, as depicted in FIG. 6, the computer system 600 may also include a disk or optical drive unit 606. The disk drive unit 606 may include a computer-readable medium 610 in which one or more sets of instructions 612, e.g. software, can be embedded. Further, the instructions 612 may embody one or more of the methods or logic as described herein. In a particular embodiment, the instructions 612 may reside completely, or at least partially, within the memory 604 and/or within the processor 602 during execution by the computer system 600. The memory 604 and the processor 602 also may include computer-readable media as discussed above.

The present disclosure contemplates a computer-readable medium that includes instructions 612 or receives and executes instructions 612 responsive to a propagated signal, so that a device connected to a network 620 can communicate voice, video, audio, images or any other data over the network 620. Further, the instructions 612 may be transmitted or received over the network 620 via a communication interface 618. The communication interface 618 may be a part of the processor 602 or may be a separate component. The communication interface 618 may be created in software or may be a physical connection in hardware. The communication interface 618 is configured to connect with a network 620, external media, the display 614, or any other components in system 600, or combinations thereof. The connection with the network 620 may be a physical connection, such as a wired Ethernet connection or may be established wirelessly as discussed below. Likewise, the additional connections with other components of the system 600 may be physical connections or may be established wirelessly.

The network 620 may include wired networks, wireless networks, or combinations thereof. The wireless network may be a cellular telephone network, an 802.11, 802.16, 802.20, or WiMax network. Further, the network 620 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Implementation of the disclosed methods and systems may also improve the efficiencies of the computer systems or other processors at the Exchange. As a result of the relationships and communication links with the other parties, one or more computer systems or other processors at the Exchange have access (e.g., convenient access) to data reflective of a clearing member firm's or other market participant's total portfolio. Such data access may be helpful in measuring each firm's level of credit risk to the Exchange (or the Exchange's clearing house). The computer systems or other processors involved in implementing risk measurement and/or management systems may thus be more effective and efficient in determining the risk level presented at any one point in time. For example, more complex risk measurement systems involving, for instance, machine learning, fuzzy logic, or other predictive engines, need not be implemented. Such efficiencies are not limited to those resulting from the access to the data reflective of the total portfolio.

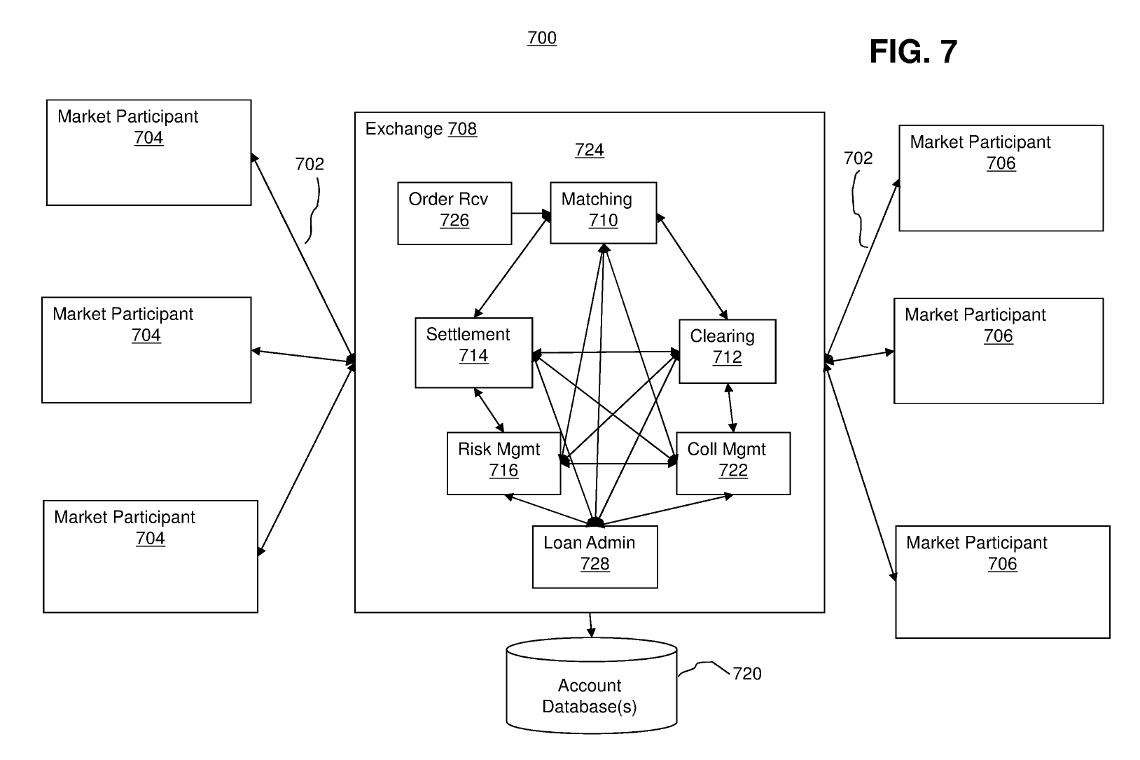

Referring now to FIG. 7, there is shown a block diagram of an exemplary network 700 for supporting the above-described transactions. The network 700 couples market participants 704, 706, with a clearing house 708, also referred to as a central counterparty or intermediary, via a communications network 702, such as the Internet, an intranet or other public or private, secured or unsecured communications network or combinations thereof. The network 700 may also be part of, or alternatively coupled with a larger trading network, allowing market participants 704, 706 to trade a variety of other products, via the clearing house 708. It will be appreciated that the plurality of entities utilizing the disclosed embodiments, e.g. the market participants 704, 706, may be referred to as lenders, borrowers, traders, trader-brokers, clearing members, clearing firms, or by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant 704, 706 and/or the clearing house 708.

The clearing house 708 provides a system 724 that implements the functions of matching 710 buy/sell or lending/borrowing transactions, clearing 712 those transactions, settling 714 those transactions and managing risk 716 among the market participants 704, 706 and between the market participants and the exchange 708, as well as administration functionality 728 for administering cleared repo transactions between delivery and redemption as will be described. In an alternate embodiment, collateral management 722 and/or request-for-quote functionality (not shown) or netting functionality (not shown) may also be provided, as is discussed in more detail below. The clearing house 708 may be include or be coupled with one or more database(s) 720 or other record keeping system which stores data related to open, i.e. un-matched, orders, matched orders which have not yet been delivered, orders, i.e. loans, which have been delivered but not yet redeemed, collateral tendered to secure outstanding loans, or combinations thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It will be appreciated that one or more of the processors, memories, logic and/or components described above may be combined or further sub-divided into discrete components thereof, and that all such implementations, accomplishing the disclosed functionality, are contemplated. Further, operation of the above components/functions may be performed on a periodic or batch basis, such as at the close of trading, and/or in real time continuously throughout the trading day or other window of time. Continuous operation may allow a market participant to monitor their margin requirements with respect to changes in their accounts.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for data structure management for clearing a transaction for a market participant, the computer implemented method comprising:
maintaining, by an account processor associated with a clearing house, a market participant account data structure for the market participant;
maintaining, by the account processor, a guaranty fund data structure representative of a guaranty fund contribution made by a clearing member in support of the market participant;
receiving, via a communication interface configured for communications via a network, transaction data for the market participant in connection with the transaction;
determining, by a transaction processor and based on the received transaction data, a settlement data level for the transaction and for which the market participant is responsible;
determining, by the transaction processor and based on the received transaction data, a guaranty fund contribution data level for the transaction and for which the clearing member is responsible;
transmitting, via the communication interface, data indicative of the determined guaranty fund contribution data level and the determined settlement data level;
adjusting, by the account processor, the market participant account data structure in accordance with the determined settlement data level; and
adjusting, by the account processor, the guaranty fund data structure in accordance with the determined guaranty fund contribution data level.

2. The computer implemented method of claim 1, further comprising:
detecting a default by the market participant; and
coordinating seizure of assets identified in the market participant account data structure upon detecting the default.

3. The computer implemented method of claim 1, further comprising adjusting, by the account processor, the market participant account data structure to reflect seizure of assets listed in the market participant account data structure in event of a default of the market participant.

4. The computer implemented method of claim 1, further comprising determining, by the transaction processor and based on the received transaction data, an initial margin data level for the transaction and for which the market participant is responsible.

5. The computer implemented method of claim 4, further comprising adjusting, by the account processor, the market participant account data structure to reflect seizure of the initial margin in event of a default of the market participant.

6. The computer implemented method of claim 5, further comprising implementing a loss recovery procedure in event of the default of the market participant and after seizure of the determined initial margin.

7. The computer implemented method of claim 6, wherein implementing the loss recovery procedure comprises adjusting the guaranty fund data structure to reflect seizure of the guaranty fund contribution of the clearing member.

8. The computer implemented method of claim 1, wherein the transaction data comprises market data for the transaction.

9. The computer implemented method of claim 1, wherein the transaction is configured to facilitate the market participant acting as a cash borrower.

10. The computer implemented method of claim 1, wherein the transaction is configured to facilitate the market participant acting as a cash lender.

11. The computer implemented method of claim 1 wherein the transaction comprises a repo transaction.

12. A system for data structure management for clearing a transaction for a market participant, the system comprising:
an account processor configured to maintain a market participant account data structure for the market participant and to maintain a guaranty fund data structure for a clearing member to make a guaranty fund contribution in support of the market participant;
a communication interface processor configured to receive, via a communication interface configured for communications via a network, transaction data for the market participant in connection with the transaction;
a transaction processor coupled to the communication interface processor configured to determine, based on the received transaction data, a settlement data level for the transaction and for which the market participant is responsible, and a guaranty fund contribution data level for the transaction and for which the clearing member is responsible;
wherein the communication interface processor is further configured to transmit, via the communication interface, data indicative of the determined settlement data level and the determined guaranty fund contribution data level; and
wherein the account processor is further configured to adjust the market participant account data structure in accordance with the determined settlement data level, and to adjust the guaranty fund data structure in accordance with the determined guaranty fund contribution data level.

13. The system of claim 12, wherein the communication interface processor is further configured to coordinate detection of a default by the market participant and seizure of assets identified in the market participant account data structure upon the detection of the default.

14. The system of claim 12, wherein the account processor is further configured to adjust the market participant account data structure to reflect seizure of assets listed in the market participant account data structure in event of a default of the market participant.

15. The system of claim 12, wherein the transaction processor is further configured to determine, based on the received transaction data, an initial margin data level for the transaction and for which the market participant is responsible.

16. The system of claim 15, wherein the account processor is further configured to adjust the market participant account data structure to reflect seizure of the initial margin in event of a default of the market participant.

17. The system of claim 16, further comprising a default processor configured to implement a loss recovery procedure in event of the default of the market participant and after seizure of the determined collateral and the determined settlement from the market participant, and after seizure of the determined initial margin.

18. The system of claim 17, wherein the account processor is further configured to adjust the guaranty fund data structure to reflect seizure of the guaranty fund contribution of the clearing member.

19. A system for data structure management for clearing a transaction for a market participant, the system comprising:
means for maintaining a market participant account data structure for the market participant;
means for maintaining a guaranty fund data structure for a clearing member to make a guaranty fund contribution in support of the market participant;
means for receiving transaction data for the market participant in connection with the transaction;
means for determining, based on the received transaction data, an initial margin data level and a settlement data level for the transaction and for which the market participant is responsible;
means for determining, based on the received transaction data, a guaranty fund contribution data level for the transaction and for which the clearing member is responsible;
means for transmitting, via the communication interface, data indicative of the determined initial margin data level, the determined settlement data level, and the determined guaranty fund contribution data level; and
means for adjusting the market participant account data structure in accordance with the determined initial margin data level and the determined settlement data level; and
means for adjusting the margin account data structure in accordance with the determined guaranty fund contribution data level.

20. A system for data structure management for clearing a transaction for a market participant, the system comprising:
a processor;
a memory coupled with the processor;
first logic stored in the memory and executable by the processor to maintain a market participant account data structure for the market participant and to maintain a guaranty fund data structure for a clearing member to make a guaranty fund contribution in support of the market participant;
second logic, coupled with the first logic, stored in the memory and executable by the processor to receive, via a communication interface configured for communications via a network, transaction data for the market participant in connection with the transaction;
third logic, coupled with the first logic and the second logic, stored in the memory and executable by the processor to determine, based on the received transaction data, an initial margin data level and a settlement data level for the transaction and for which the market participant is responsible, and a guaranty fund contribution data level for the transaction and for which the clearing member is responsible; and
fourth logic, coupled with the first logic and the third logic, stored in the memory and executable by the processor to adjust the market participant account data structure in accordance with the determined initial margin data level and the determined settlement data level, and to adjust the guaranty fund data structure in accordance with the determined guaranty fund contribution data level.
